(19) United States
(12) Patent Application Publication
(10) Pub. No.: US 2025/0105712 A1
(43) Pub. Date: Mar. 27, 2025

(54) METHOD OF MANUFACTURING A COIL

(71) Applicant: TOYOTA JIDOSHA KABUSHIKI KAISHA, Toyota-shi (JP)

(72) Inventors: Masashi MATSUMOTO, Nagoya-shi (JP); Ken SHIRAI, Toyota-shi (JP); Hazuki KAWAMURA, Nisshin-shi (JP)

(21) Appl. No.: 18/889,568

(22) Filed: Sep. 19, 2024

(30) Foreign Application Priority Data
Sep. 21, 2023 (JP) 2023-155713

(51) Int. Cl. H02K 15/06

(52) U.S. Cl. CPC H02K 15/06

(57) ABSTRACT

A method of manufacturing a coil includes: a first step of connecting a plurality of first coils to one end of respective a plurality of connecting members; and a second step of inserting the first coils, which are connected to the respective connecting members, and a plurality of second coils into slots of a stator core, so that the second coils are connected to the respective connecting members, which have already been connected to the first coils. Further, in the second step, in a case where insert directions of the two first coils adjacent to each other to be inserted into the slots are different from each other, a sum of insertion amounts of the two first coils adjacent to each other is less than a total length of each of the slots.

### CROSS-REFERENCE TO RELATED APPLICATION(S)

The present application claims priority to and incorporates by reference the entire contents of Japanese Patent Application No. 2023-155713 filed in Japan on Sep. 21, 2023.

### BACKGROUND

The present disclosure relates to a method of manufacturing a coil.

Japanese Patent No. 7003674 discloses a technique for securing insulation between coils by arranging connecting members which connect coils in slots of a stator core by shifting connecting members adjacent in the radial direction in the axial direction.

### SUMMARY

There is a need for providing a method of manufacturing a coil capable of suppressing damage to the coating of the coil.

According to an embodiment, a method of manufacturing a coil includes: a first step of connecting a plurality of first coils to one end of respective a plurality of connecting members; and a second step of inserting the first coils, which are connected to the respective connecting members, and a plurality of second coils into slots of a stator core, so that the second coils are connected to the respective connecting members, which have already been connected to the first coils. Further, in the second step, in a case where insert directions of the two first coils adjacent to each other to be inserted into the slots are different from each other, a sum of insertion amounts of the two first coils adjacent to each other is less than a total length of each of the slots.

### BRIEF DESCRIPTION OF THE DRAWINGS

FIG. 1 is a diagram for explaining a first series of connection steps of a method for manufacturing a coil according to the embodiment;

FIGS. 2A and 2B are diagrams for explaining a coil molding process of a method for manufacturing a coil according to the embodiment;

FIG. 3 is a diagram for explaining a second connecting step of the method of manufacturing a coil according to the embodiment;

FIG. 4 is a diagram illustrating an example of a coil manufactured by the method of manufacturing a coil according to the embodiment;

FIG. 5 is a diagram for explaining the relationship between the total length of the slot and the total insertion amount of the two coils in the second connecting step of the method of manufacturing a coil according to the embodiment;

FIG. 6 is a diagram for explaining the relationship between the total length of the slot and the total insertion amount of the two coils in the second connecting step of the method of manufacturing a coil according to the embodiment;

FIG. 7 is a diagram for explaining the relationship between the total length of the slot and the total insertion amount of two coils in the second connecting step of the method of manufacturing a coil according to the embodiment;

FIG. 8 is a diagram for explaining the relationship between the total length of the slot and the total insertion amount of the two coils in the second connecting step of the method of manufacturing a coil according to the embodiment;

FIG. 9 is a diagram illustrating another example of a coil manufactured by the method of manufacturing a coil according to the embodiment;

FIG. 10 is a diagram illustrating another example of a coil manufactured by the method of manufacturing a coil according to the embodiment; and

FIG. 11 is a diagram illustrating another example of a coil manufactured by the method of manufacturing a coil according to the embodiment.

### DETAILED DESCRIPTION

In the technique disclosed in Japanese Patent No. 7003674, during the manufacture of the coil, the adjacent connecting member and the coil is in contact, there is a possibility that the coating of the coil is damaged (peeled off).

A method of manufacturing a coil according to an embodiment of the present disclosure will be described with reference to the drawings. In addition, components in the following embodiments include those which can be substituted and easily by those skilled in the art, or those which are substantially the same.

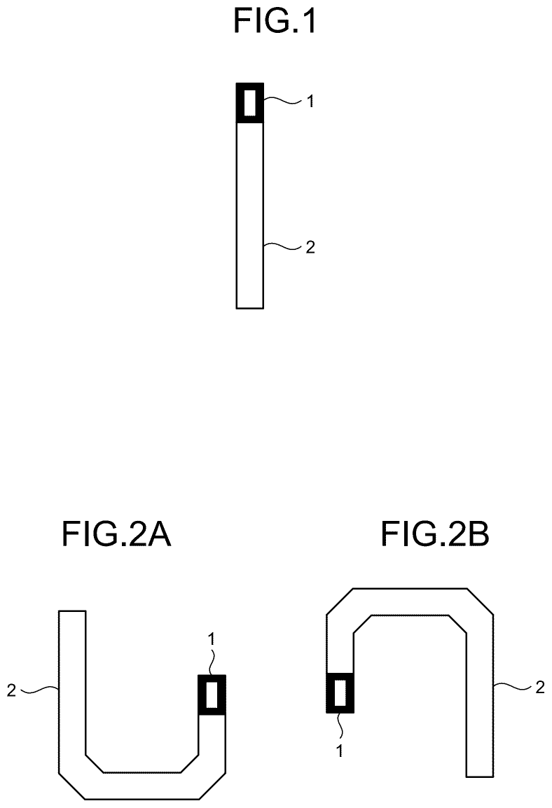

A method of manufacturing the coil according to the embodiment will be described with reference to FIGS. 1 to 4. The Method for producing a coil according to the embodiment refers to, for example, a method for producing a coil (stator coil) used in the assembled stator. In the method of manufacturing a coil according to the embodiment, there are a series of connecting step (first step), and a coil molding step, and a second connecting step (second step). Hereinafter, details of each step of the method for manufacturing a coil according to the embodiment.

### Step 1

In the first connecting step, as illustrated in FIG. 1, a coil 2 is connected to one end of a connecting member 1. The connecting member 1 is, for example, a copper tube formed in a hollow shape. Further, the coil 2 is made of a plate-shaped aluminum or the like, and a coating (insulating coating) is formed on the surface.

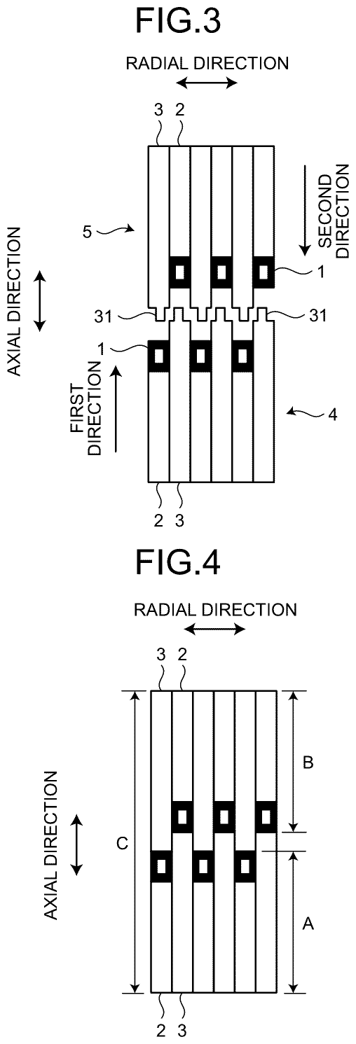

Incidentally, in the coil 2, the portion connected to one end of the connecting member 1 is not formed a coating, the conductor is exposed (see conductor exposed portion 31 in FIG. 3 to be described later).

### Coil Forming Process

In the coil forming step, as illustrated in parts (a) and (b) of FIG. 2, the coil 2 is molded into a segment coil shape. In this coil forming step, the legs of the coil 2 performs molding so that the connecting member 1 is positioned shorter.

### Second Connecting Step

In the second connecting step, as illustrated in FIG. 3, a plurality of coils (first coil) 2 connecting the connecting member 1, a plurality of coils (second coil) 3, each inserted into the slot of the stator core, the other end of the connecting member 1 which is connected to the coil 2 to connect the coil 3. The coil 3 is a coil in which the connecting member 1 is not connected, and includes a conductor exposed portion 31 where the coating is not formed.

In FIG. 3, the vertical direction of the paper surface is the axial direction of the stator core, the lateral direction of the paper surface is the radial direction of the stator core. The depth direction of the paper surface is the circumferential direction of the stator core. Further, in the figure, the stator core, and the illustration of the slot of the stator core are omitted.

In the second connecting step, specifically, as illustrated in FIG. 3, a coil group in which a plurality of coils 2 and a plurality of coils 3 are combined (first coil group) 4, is inserted into the slot from the first direction. Further, a coil group in which a plurality of coils 2 and a plurality of coils 3 are combined (second coil group) 5 is inserted into the slot from the second direction opposite to the first direction. Thus, as illustrated in FIG. 4, the other end of the connecting member 1 which is connected to a plurality of coils 2, respectively connecting the conductor exposed portion 31 of the coil 3.

Further, in the second connecting step, the coil groups 4 and 5 are inserted in the same slot of the stator core (one slot). That is, in the example of FIG. 3, with respect to the same slot, a coil group 4 in which the coils 2 and 3 are combined alternately three in the radial direction of the stator core, the coil group 5 in which the coils 2 and 3 are combined alternately three in the radial direction of the stator core, are inserted from different directions.

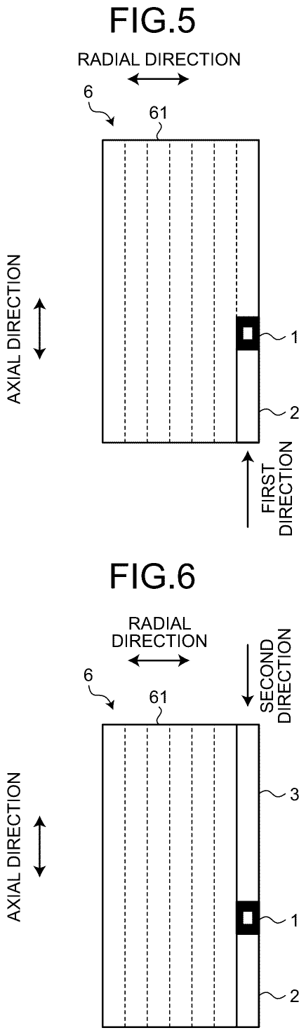

Further, in the second connecting step, when the insertion direction of the two adjacent coils 2 inserted into the slot are different, as illustrated in FIG. 4, the total insertion amount of the two adjacent coils 2 inserted into the slot A +B is shorter than the total length C of the slot. Incidentally, the term “adjacent two coils 2” refers that, in the same slot, the two coils 2 arranged adjacent to each other in the radial direction of the stator core. Further, the A, B of the inserted quantity of the coil 2 may be a length including the connecting member 1. Hereinafter, the relationship between the total insertion amount of the two coils 2 and the total length of the slot will be described in detail with reference to FIGS. 5 to 8.

FIGS. 5 to 8 indicate a state that in the second connecting step, a portion of the coils 2 and 3 to be inserted into one slot 61 of the stator core 6 are illustrated. Note that these figures, unlike FIGS. 1 to 4 described above, do not illustrate the actual process of the method of manufacturing a coil according to the embodiment.

For example, as illustrated in FIG. 5, with respect to the slot 61 of the stator core 6, the coil 2 connecting member 1 is connected, is inserted from the first direction. In this case, as illustrated in FIG. 6, the coil 3 connecting member 1 is not connected, by being inserted into the slot 61 from the second direction, the coil 2 and the coil 3 are connected in the slot 61.

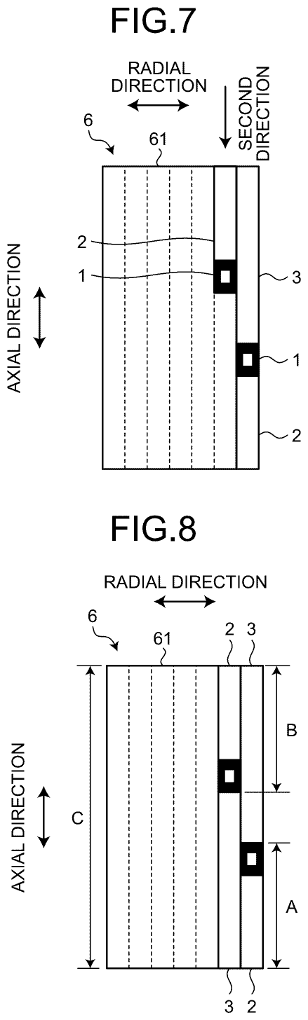

On the other hand, as illustrated in FIG. 7, next to the coils 2, 3 inserted into the slot 61 in FIG. 5 and FIG. 6 described above (position adjacent to the radial direction of the stator core), the coil 2 connecting member 1 is connected, it is inserted from the second direction. In this case, as illustrated in FIG. 8, the coil 3 connecting member 1 is not connected, by being inserted into the slot 61 from the first direction, the coil 2 and the coil 3 are connected in the slot 61.

Thus, if the insertion direction of the two coils 2 adjacent in the slot 61 is different, the total A+B is shorter than the total length C of the slot 61, where the A refers to the insertion amount A of the first coil 2, and the B refers to the insertion amount B of the second coil 2. That is, to satisfy the relationship of “insertion amount A+B<total length C of the slot 61 of the coil 2”.

Here, when the “insertion amount A+B<total length C of the slot 61 of the coil 2” is described in other words, in the second connecting step, the connecting member 1 of the two coils 2 adjacent in the radial direction is not passing each other, and the positions of the two connecting members 1 are apart from each other in the axial direction. Incidentally, the inserting quantity A, B of the coil 2 may be a length including the connecting member 1.

For example, when the relationship “the insertion amount A+B of the coil 2=the total length C of the slot 61” satisfies, the position of the two connecting members 1 adjacent in the radial direction coincides in the axial direction, i.e., two connecting members 1 are side-by-side in the radial direction. In this case, in the second connecting step, the connecting member 1 and the coils 2, 3 adjacent are in contact, there is a possibility that the coating of the coils 2, 3 is damaged. Furthermore, since the conductor exposed portion 31 of the coil 3 is side-by-side in the radial direction (the axial position of the conductor exposed portion 31 is matched), there is a possibility that cannot ensure insulation between the coils 2 and 3.

Further, when the relationship “the insertion amount A+B of the coil 2>the total length C of the slot 61” is satisfied, in the second connecting step, the two connecting members 1 adjacent in the radial direction will be passed each other. Therefore, the adjacent connecting member 1 and the coils 2, 3 are in contact, there is a possibility that the coating of the coils 2, 3 is damaged.

On the other hand, in the second connecting step of the method of manufacturing a coil according to the embodiment, by satisfying the relationship “the insertion amount A+B<total length C of the slot 61 of the coil 2”, the two connecting members 1 adjacent in the radial direction do not pass each other. Therefore, the adjacent connecting member 1 and the coils 2, 3 are no longer in contact, so that it is possible to suppress damage to the coating of the coils 2, 3. Furthermore, since the conductor exposed portion 31 of the coil 3 is not aligned laterally in the radial direction (the axial position of the conductor exposed portion 31 does not coincide), it is possible to ensure insulation between the coils 2 and 3.

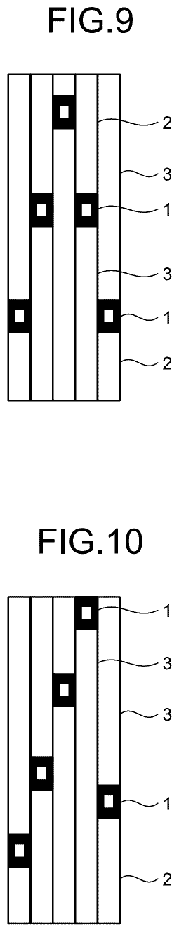

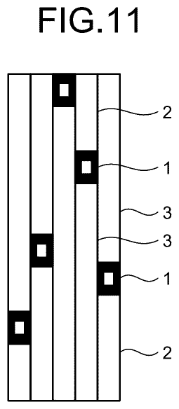

Here, FIG. 4 described above is an example of a coil manufactured by the method of manufacturing a coil according to the embodiment, it should be noted that as long as it satisfies the condition of “the insertion amount A+B<total length C of the slot 61 of the coil 2”, the present disclosure is not limited to this example. For example, by changing the insertion amount of the coil 2 with respect to the slot 61 from FIG. 4, it may be manufactured coil as illustrated in FIGS. 9 to 11. In the coils illustrated in the figures, the condition of “the insertion amount A+B of the coil 2<total length C of the slot 61” is satisfied.

According to the manufacturing method of the coil according to the embodiment described above, by the “insertion amount A+B<total length C of the slot 61 of the coil 2”, it is possible to suppress damage to the coating of the coil 2, 3.

That is, in the assembled stator, since the conductor exposed portion of the coil in the slot 61 (e.g., conductor exposed portion 31) is present, securing the insulation of the conductor exposed portion is desired. Therefore, as illustrated in FIG. 4, by shifting the position of the connecting member 1 covering the conductor exposed portion in the axial direction, insulation is ensured.

On the other hand, when shifted simply in the axial direction the position of the connecting member 1, the connecting member 1 to each other is passed each other in the second connecting step, there is a possibility that the coating of the adjacent coils 2 and 3 is damaged.

Therefore, in the method of manufacturing a coil according to the embodiment, as illustrated in FIG. 2, the connecting member 1 is provided to the side where leg of the coil 2 is shorter. Thus, in the second connecting step, since the connecting member 1 to each other is no longer passing each other, damage to the coating of the coils 2, 3 is suppressed.

Further effects and variations can be readily derived by one skilled in the art. Thus, the broader aspects of the invention are not limited to the specific details and representative embodiments represented and described above. Accordingly, various changes may be made without departing from the spirit or scope of the overall inventive concept defined by the appended claims and their equivalents.

According to an embodiment, it is possible to suppress damage to the coating of the coil.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a coil comprising:
a first step of connecting a plurality of first coils to one end of respective a plurality of connecting members; and
a second step of inserting the first coils, which are connected to the respective connecting members, and a plurality of second coils into slots of a stator core, so that the second coils are connected to the respective connecting members, which have already been connected to the first coils, wherein
in the second step, in a case where insert directions of the two first coils adjacent to each other to be inserted into the slots are different from each other, a sum of insertion amounts of the two first coils adjacent to each other is less than a total length of each of the slots.
